(19) United States
(12) Patent Application Publication
(10) Pub. No.: US 2019/0043235 A1
(43) Pub. Date: Feb. 7, 2019

(54) SUPPORT IMAGE DISPLAY APPARATUS, SUPPORT IMAGE DISPLAY METHOD, AND COMPUTER READABLE MEDIUM

(71) Applicant: MITSUBISHI ELECTRIC CORPORATION, Tokyo (JP)

(72) Inventors: Naoyuki TSUSHIMA, Tokyo (JP); Masahiro ABUKAWA, Tokyo (JP)

(73) Assignee: MITSUBISHI ELECTRIC CORPORATION, Tokyo (JP)

(21) Appl. No.: 16/074,912

(22) PCT Filed: Mar. 24, 2016
(86) PCT No.: PCT/JP2016/059481

§ 371 Date: Aug. 2, 2018

(51) Int. Cl. G06T 11/60; G01C 21/26; G09G 5/38

(52) U.S. Cl. CPC G06T 11/60; G01C 21/26; G08G 1/0969; G09G 2380/10; G09G 2340/12; G09G 5/38

(57) ABSTRACT

An image generation unit generates a support image indicating a reference position of an object. A visibility determination unit determines whether or not a reference range based on the reference position can be visually recognized from a moving body. If it has been determined that the reference range can be visually recognized, a display control unit causes the support image to be displayed, such that the support image without alteration is superimposed on a landscape around the moving body. If it has been determined that the reference range cannot be visually recognized, the display control unit alters the support image, and then causes the altered support image to be displayed, such that the altered support image is superimposed on the landscape around the moving body.

### TECHNICAL FIELD

The present invention relates to a technology for performing driving support by displaying a support image indicating an object that is present ahead of a vehicle.

### BACKGROUND ART

A driver performs driving while grasping various pieces of information presented by a driving support apparatus such as a navigation apparatus.

Among driving support apparatuses, there is the one like a head-up display, which superimposes a support image indicating the name of a building or the like on a forward landscape and displays, on a windshield, the support image superimposed on the landscape. There is also a driving support apparatus that displays, on a display unit such as an LCD (Liquid crystal display), a forward landscape photographed by a camera and superimposes and displays a support image on the landscape.

When the information is displayed by being superimposed on the landscape as mentioned above, the driver will be confused if a display position of the support image is deviated from an object targeted by the support image. Patent Literature 1 describes a technology for displaying the name of an object in a display region of the object in order to cope with this problem.

### CITATION LIST

### Patent Literature

Patent Literature 1: JP H09-281889 A

### SUMMARY OF INVENTION

### Technical Problem

In Patent Literature 1, the name is displayed only for a structure that can be seen from a driver. Therefore, according to the technology described in Patent Literature 1, the name cannot be displayed for a structure located in a position that cannot be seen from the driver due to a different structure.

An object of the present invention is to display a support image so that a driver may easily understand the support image even for a structure located in a position that cannot be seen from the driver due to a different structure.

### Solution to Problem

A support image display apparatus according to the present invention causes a support image to be-displayed, such that the support image is superimposed on a landscape that is observed from a viewpoint position of a moving body, the support image indicating a reference position of an object included in the landscape, and the support image display apparatus includes:

an image generation unit to generate the support image;

a visibility determination unit to determine whether or not a structure that is present between the moving body and the object overlaps a reference range based on the reference position of the object, in the landscape; and
a display control unit to alter the support image and cause the altered support image to be displayed when the reference range overlaps the structure.

### Advantageous Effects of Invention

In the present invention, when the reference range based on the reference position indicated by the support image cannot be visually recognized, the support image is altered, and is then displayed by being superimposed on the landscape. With this arrangement, even for the structure located in a position that cannot be seen from a driver due to the different structure, the support image can be so displayed that the driver may easily understand the support image.

### BRIEF DESCRIPTION OF DRAWINGS

FIG. 1 is a configuration diagram of a support image display apparatus 10 according to a first embodiment.

FIG. 2 is a flowchart illustrating overall processes of the support image display apparatus 10 according to the first embodiment.

FIG. 3 includes explanatory diagrams of the processes according to the first embodiment when a structure 53 is not present.

FIG. 4 includes explanatory diagrams of the processes according to the first embodiment when the structure 53 is present.

FIG. 5 is a flowchart illustrating an image generation process according to the first embodiment.

FIG. 6 is a flowchart illustrating a visibility determination process according to the first embodiment.

FIG. 7 is an explanatory diagram of a process of determining whether or not the structure 53 is present according to the first embodiment.

FIG. 8 is an explanatory diagram of a process of computing an invisible area 54 according to the first embodiment. FIG. 9 is an explanatory diagram of a process of computing a movement amount M according to the first embodiment.

FIG. 10 is a flowchart illustrating a display control process according to the first embodiment.

FIG. 11 is an explanatory diagram of a process of determining whether or not the structure 53 is present according to a first variation.

FIG. 12 is an explanatory diagram of a process of identifying a reference range 62 according to the first variation.

FIG. 13 is an explanatory diagram of a process of computing a movement amount M according to the first variation.

FIG. 14 is a flowchart illustrating a visibility determination process in step S2 according to a second variation.

FIG. 15 is a configuration diagram of a support image display apparatus 10 according to a third variation.

FIG. 16 is a flowchart illustrating a visibility determination process in step S2 according to a second embodiment.

FIG. 17 is an explanatory diagram of a process of computing an alteration range L according to the second embodiment.

FIG. 18 is a flowchart illustrating a display control process according to the second embodiment.

FIG. 19 is an explanatory diagram of a support image 41 to be displayed according to the second embodiment.

### DESCRIPTION OF EMBODIMENTS

### First Embodiment

### Description of Configuration

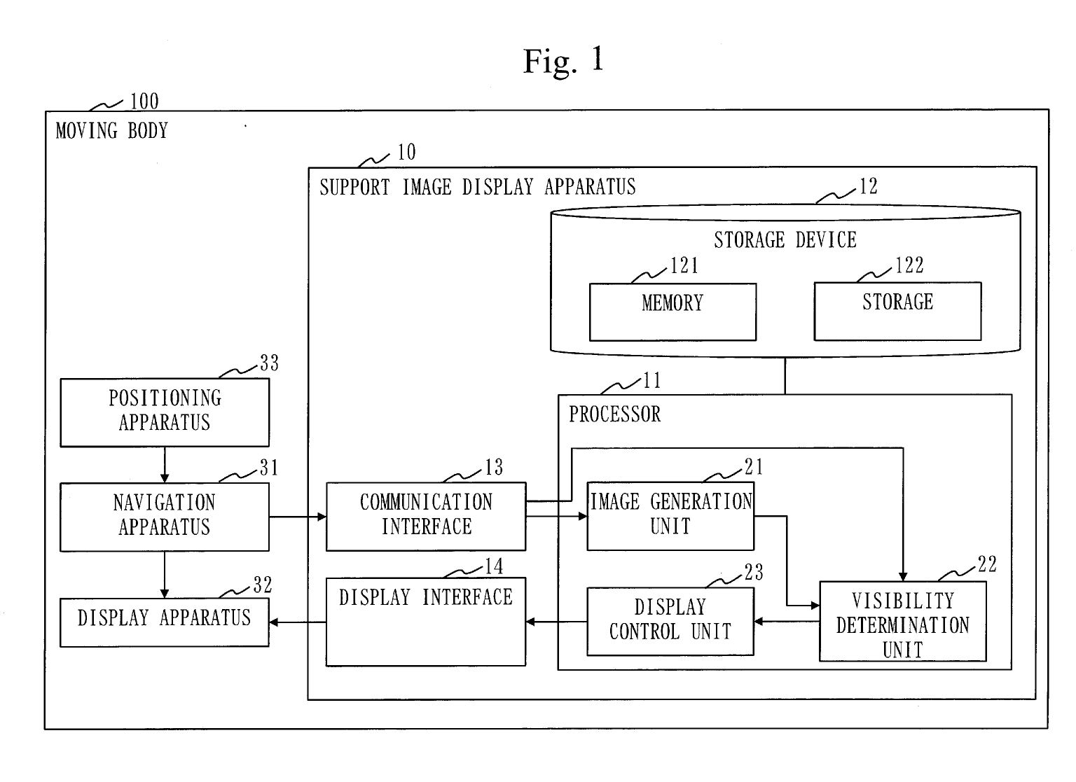

A configuration of a support image display apparatus 10 according to a first embodiment will be described with reference to FIG. 1.

The support image display apparatus 10 is a computer that is mounted on a moving body 100 and performs display control of point of interest (POI) information which a navigation apparatus 31 causes a display apparatus 32 to display. In the first embodiment, the moving body 100 is a vehicle. The moving body 100 is not limited to the vehicle and may be a different type such as a ship or a pedestrian.

The support image display apparatus 10 includes a processor 11, a storage device 12, a communication interface 13, and a display interface 14. The processor 11 is connected to the other hardware via signal lines and controls these other hardware.

The processor 11 is an integrated circuit (IC) to perform processing. As a specific example, the processor 11 is a central processing unit (CPU), a digital signal processor (DSP), or a graphics processing unit (GPU).

The storage device 12 includes a memory 121 and a storage 122. As a specific example, the memory 121 is a random access memory (RAM). As a specific example, the storage 122 is a hard disk drive (HDD). Alternatively, the storage 122 may be a portable storage medium such as an Secure Digital (SD) memory card, a CompactFlash (CF), a NAND flash, a flexible disk, an optical disk, a compact disk, a blue-ray (registered trademark) disk, or a DVD.

The communication interface 13 is a device to connect an apparatus such as the navigation apparatus 31 mounted on the moving body 100. As a specific example, the communication interface 13 is a connection terminal of USB (Universal Serial Bus) or IEEE1394.

The navigation apparatus 31 is a computer to identify the position of the moving body 100, using a positioning apparatus 33 and cause the display apparatus 32 to display a route to a destination or a way point based on the identified position, thereby performing route guidance to the destination or the way point. The navigation apparatus 31 is a computer that includes map information and causes the display apparatus 32 to display the POI information specified by a driver or automatically extracted, thereby presenting the POI information to the driver.

The POI information is information on an object in which the driver is estimated to take interest and is information indicating the position, the shape or the like of the object. As a specific example, the POI information is information on the object corresponding to a specified classification when the classification such as a drugstore or a restaurant is specified by the driver.

The positioning apparatus 33 is an apparatus to receive a positioning signal on a carrier wave, which has been transmitted from a positioning satellite such as a GPS (Global Positioning System) satellite.

The display interface 14 is a device to connect the display apparatus 32 mounted on the moving body 100. As a specific example, the display interface 14 is a connection terminal of USB or HDMI (registered trade mark, High-Definition Multimedia Interface).

The display apparatus 32 is an apparatus to superimpose and display information on a landscape around the moving body 100 such as ahead of the moving body 100. The landscape herein is one of an actual object seen through a head-up display or the like, an image obtained by a camera, or a three-dimensional map generated by computer graphics.

The support image display apparatus 10 includes an image generation unit 21, a visibility determination unit 22, and a display control unit 23, as a functional configuration. A function of each unit of the image generation unit 21, the visibility determination unit 22, and the display control unit 23 is implemented by software.

A program to implement the function of each unit in the support image display apparatus 10 is stored in the storage 122 of the storage device 12. This program is loaded into the memory 121 by the processor 11 and is executed by the processor 11. This causes the function of each unit of the support image display apparatus 10 to be implemented.

Information, data, signal values, and variable values indicating results of processes of the functions of the respective units that are implemented by the processor 11 are stored in the memory 121 or a register or a cache memory in the processor 11. In the following expression, the description will be given, assuming that the information, the data, the signal values, and the variable values indicating the results of the processes of the functions of the respective units that are implemented by the processor 11 are stored in the memory 121.

The program to implement each function that is implemented by the processor 11 has been assumed to be stored in the storage device 12. This program may be, however, stored in a portable storage medium such as a magnetic disk, a flexible disk, an optical disk, a compact disk, a blue-ray (registered trademark) disk, or a DVD.

FIG. 1 illustrates only one processor 11. There may be, however, a plurality of the processors 11, and the plurality of the processors 11 may cooperate and execute the program to implement each function.

### Description of Operations

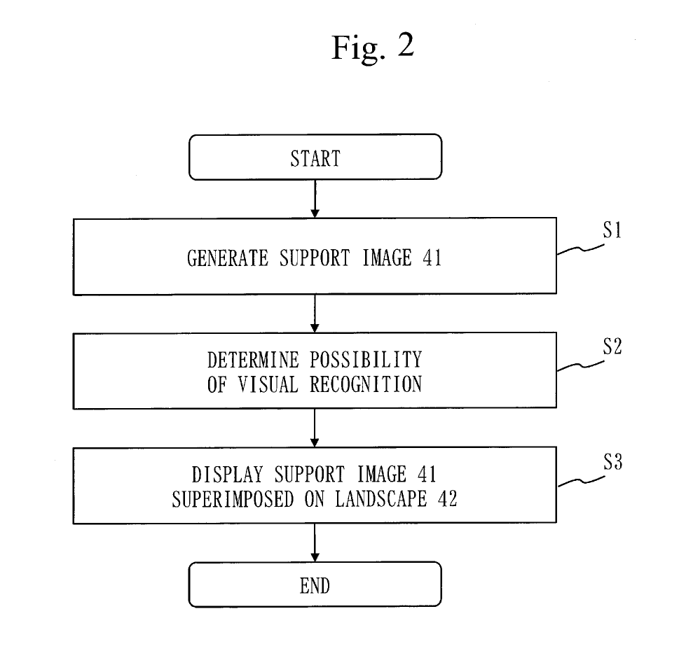

Operations of the support image display apparatus 10 according to the first embodiment will be described with reference to FIGS. 2 to 10.

The operations of the support image display apparatus 10 according to the first embodiment correspond to a support image display method according to the first embodiment. The operations of the support image display apparatus 10 according to the first embodiment correspond to a support image display program procedure according to the first embodiment.

Overall processes of the support image display apparatus 10 according to the first embodiment will be described with reference to FIGS. 2 to 4.

The processes illustrated in FIG. 2 are executed when the navigation apparatus 31 causes the display apparatus 32 to display POI information. When the navigation apparatus 31 causes display of the POI information, the navigation apparatus 31 transmits the POI information to the support image display apparatus 10.

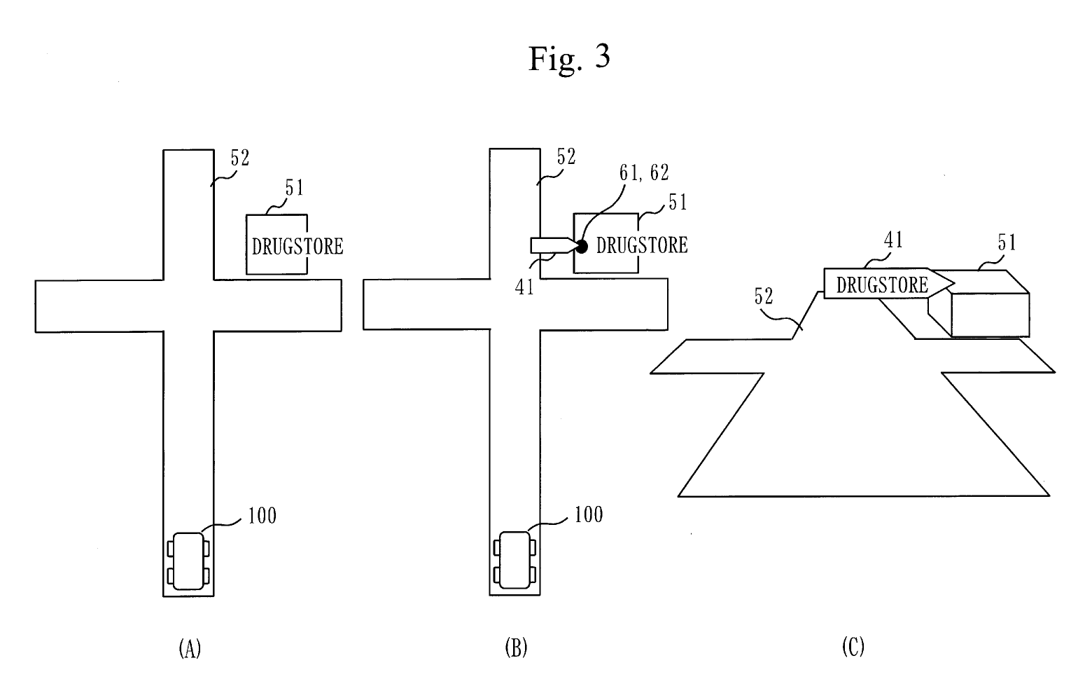

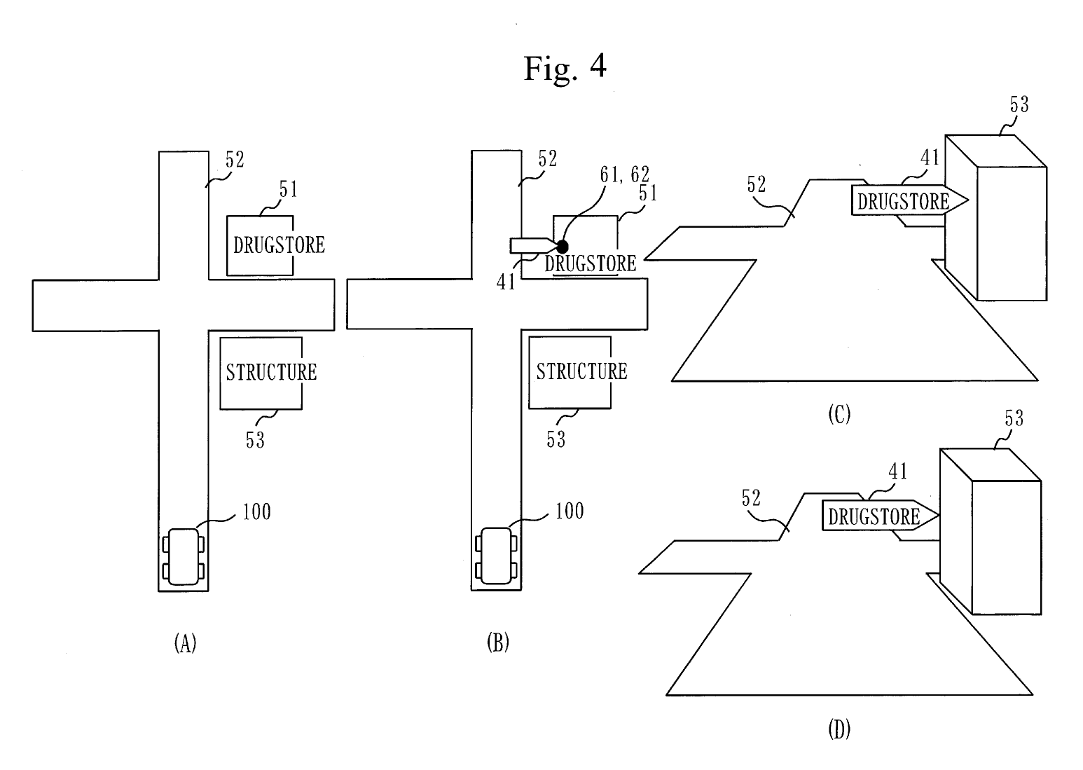

Herein, the description will be given, assuming that an object 51 of the POI information is a drugstore. FIG. 3 and FIG. 4 are different in that, while a structure 53 is not present between the moving body 100 and the object 51 in FIG. 3 as illustrated in A of FIG. 3, the structure 53 is present in FIG. 4, as illustrated in A of FIG. 4.

In an image generation process in step S1, the image generation unit 21 generates a support image 41 indicating a reference position 61 for the object 51 of the POI information, as illustrated in each of B of FIG. 3 and B of FIG. 4 and writes the generated support image 41 into the memory 121. The reference position 61 is a position used for reference when the object is indicated by the support image. In the first embodiment, the reference position 61 is a point on the object 51. The support image 41 indicates the object 51 and is an image for explaining this object. To take an example, an image such as a virtual signboard indicating the object 51 corresponds to this.

In a visibility determination process in step 52, the visibility determination unit 22 determines whether or not a reference range 62 based on the reference position 61 can be visually recognized from the moving body 100. That is, the visibility determination unit 22 determines whether or not the structure 53 located between the moving body 100 and the object 51 overlaps the reference range 62 based on the reference position 61 of the object 51, in a landscape that is observed from the viewpoint position of the moving body. The reference range 62 indicates an arbitrary range determined from the reference position in advance. The arbitrary range may be the same as the reference point. That is, the reference point and the reference range may be the same range. In the first embodiment, the reference range 62 is a point indicating the reference position 61.

In a display control process in step S3, the display control unit 23 reads, from the memory 121, the support image 41 generated in step S1. Then, the display control unit 23 causes the display apparatus 32 to display the support image 41 that has been read, such that the support image 41 is superimposed on a landscape 42.

In this case, if it has been determined in step S2 that the reference range 62 can be visually recognized or if the reference range 62 does not overlap the structure 53, the display control unit 23 causes the display apparatus 32 to display the support image 41 that has been read, such that the support image 41 without alteration is superimposed on the landscape 42.

That is, when the structure 53 is not present between the moving body 100 and the drugstore being the object 51 as illustrated in A of FIG. 3, the display control unit 23 does not alter the support image 41 that has been read, and causes the display apparatus 32 to display the support image 41 superimposed on the landscape 42, as illustrated in C of FIG. 3.

On the other hand, if it has been determined in step S2 that the reference range 62 cannot be visually recognized, or the reference range 62 overlaps the structure 53, the display control unit 23 alters the support image 41 that has been read, and then causes the display apparatus 32 to display the altered support image 41 superimposed on the landscape 42 around the moving body 100. The alteration of the support image 41 includes alteration of a position or alteration of a display form of the support image 41. In the first embodiment, a description will be given about an example in which the display control unit 23 alters a position indicated by the support image 41 and then causes the display apparatus 32 to display the altered support image 41.

In other words, assume that the structure 53 is present between the moving body 100 and the drugstore being the object 51 as illustrated in A of FIG. 4. If the display control unit 23 causes the display apparatus 32 to display the support image 41 that has bee read, such that the support image 41 without alteration is superimposed on the landscape 42, as illustrated in C of FIG. 4, the position indicated by the support image 41 overlaps the structure 53 and the drugstore being the object 51 is seen as if the drugstore were present in the structure 53.

Then, the display control unit 23 causes the display apparatus 32 to display the support image 41 after shifting the position indicated by the support image 41 to the side of a road 52, as illustrated in D of FIG. 4. This facilitates recognition of presence of the drugstore being the object 51 on the back side of the structure 53. This facilitates recognition of presence of the drugstore being the object 51 on the back side of the structure 53.

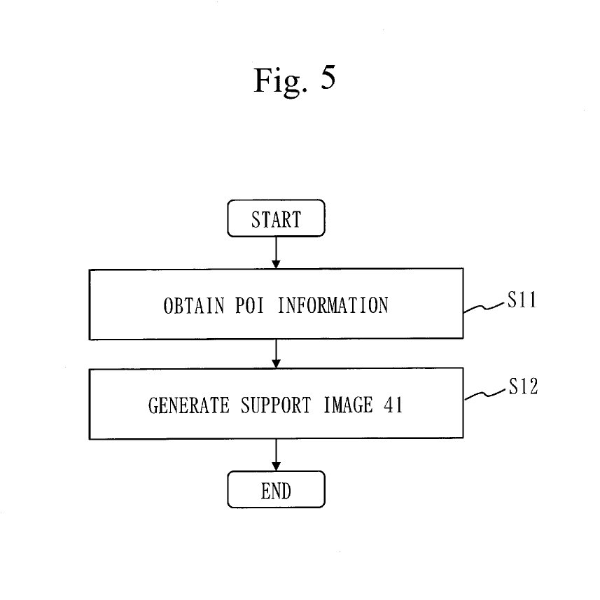

An image generation process in step S1 according to the first embodiment will be described with reference to FIG. 5.

In step S11, the image generation unit 21 obtains the POI information transmitted from the navigation apparatus 31 via the communication interface 13 in step S11. The image generation unit 21 writes the obtained POI information into the memory 121.

The POI information is information indicating the position and the shape of the object 51. In the first embodiment, the information indicating the shape of the object 51 is assumed to indicate a planar shape when the object 51 is seen from the sky, and the planar shape of the object 51 is assumed to be rectangular. Then, the PIO information is assumed to be information indicating latitudes and longitudes of four left upper, right upper, left lower, and right lower points when the object 51 is seen from the sky. Herein, since the object 51 is the drugstore, the POI information is information indicating latitudes and longitudes of four points of the drugstore located around the moving body 100.

In step S12, the image generation unit 21 generates the support image 41 indicating the object 51 given by the POI information obtained in step S11.

Specifically, the image generation unit 21 reads, from the memory 121, the POI information obtained in step S11. The image generation unit 21 identifies the reference position 61 of the object 51 from the POI information. Then, the image generation unit 21 generates the support image 41 indicating the identified reference position 61 of the object 51 and extending to the road 52. The image generation unit 21 writes, into the memory 121, the reference position 61 that has been computed and the generated support image 41.

As a specific example of a method of identifying the reference position 61, the image generation unit 21 identifies one of the four points of the object 51 closest to the road 52 using the latitudes and longitudes of the four points indicated by the POI information. If there are two points closest to the road 52, the image generation unit 21 selects one of the two points. The image generation unit 21 computes a position shifted from the identified point toward the point of the object 51 positioned diagonally to the identified point, by a certain distance. The image generation unit 21 computes a position obtained by shifting the computed position in a height direction or shifting the computed position from the ground surface in a vertical direction, just by a reference height, and sets the computed position as the reference position 61.

Each support image 41 in FIG. 3 and FIG. 4 is an image in the form of an arrow. Then, the support image 41 is an image whose position of the tip of the arrow overlaps the reference position 61 and extends to the road 52. Further, the support image 41 is an image indicating the name, the type, or the like of the object 51. The shape of the support image 41 is not limited to the arrow and may have a different shape such as a balloon.

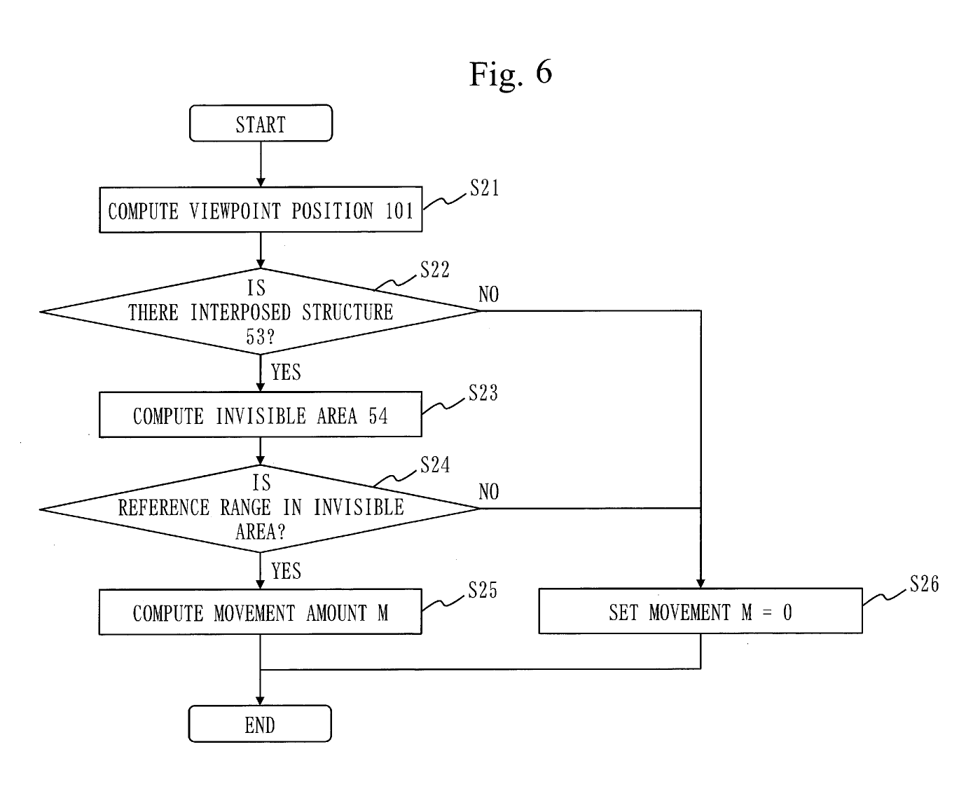

The visibility determination process in step S2 according to the first embodiment will be described with reference to FIG. 6.

In step S21, the visibility determination unit 22 computes a viewpoint position 101 of the driver of the moving body 100.

Specifically, the visibility determination unit 22 obtains position information indicating a position of the moving body 100 from the navigation apparatus 31. Then, the visibility determination unit 22 computes the viewpoint position 101 of the driver using the position indicated by the position information. As a specific example, the visibility determination unit 22 stores, in the memory 121, relative position information indicating the relative position of the viewpoint position 101 of the driver with respect to the position indicated by the position information that is obtained from the navigation apparatus 31, in advance. Then, the visibility determination unit 22 computes the viewpoint position 101, using this relative position information. The visibility determination unit 22 writes the computed viewpoint position 101 into the memory 121.

In step S22, the visibility determination unit 22 determines whether or not the structure 53 is present between the viewpoint position 101 computed in step S21 and the object 51.

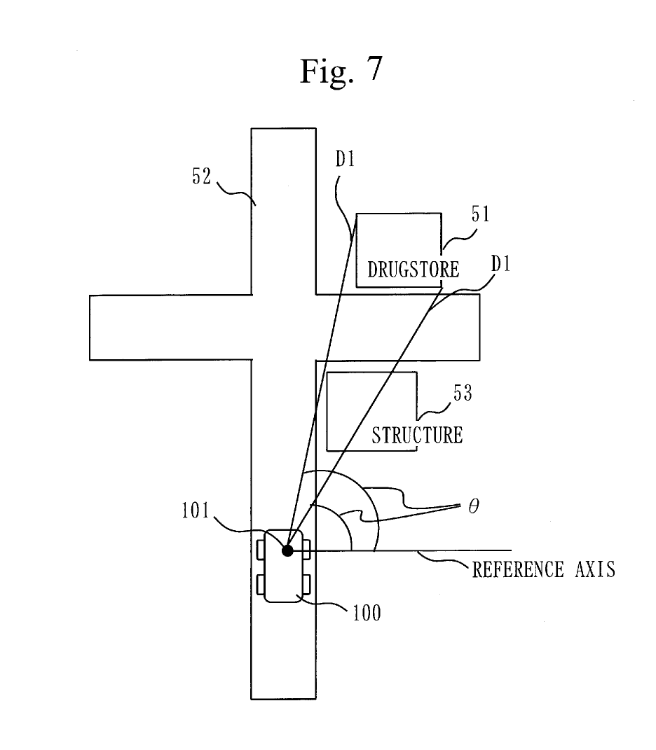

Specifically, the visibility determination unit 22 reads, from the memory 121, the viewpoint position 101 computed in step S21 and the POI information obtained in step S11. As illustrated in FIG. 7, the visibility determination unit 22 computes two straight lines D1 that have connected the viewpoint position 101 and two points located at both ends of the four points of the object 51 indicated by the POI information. The two straight lines D1 are computed by computing, among straight lines that have connected the viewpoint position 101 and the respective four points of the object 51, the straight lines each of which makes an angle θ formed with a reference axis minimum and maximum. A right direction from the viewpoint position 101 with respect to the travel direction of the moving body 100 is used as the reference axis. Then, the visibility determination unit 22 determines whether or not the structure 53 is present in a range enclosed among the viewpoint position 101, the computed two straight lines, and the object 51, by referring to the map information included in the navigation apparatus 31.

If the structure 53 is present, the visibility determination unit 22 causes the procedure to step S23. If the structure 53 is not present, the visibility determination unit 22 causes the procedure to step S26.

In step S23, the visibility determination unit 22 computes an invisible area 54 that cannot be seen from the viewpoint position 101 due to the structure 53 which is present between the viewpoint position 101 and the object 51.

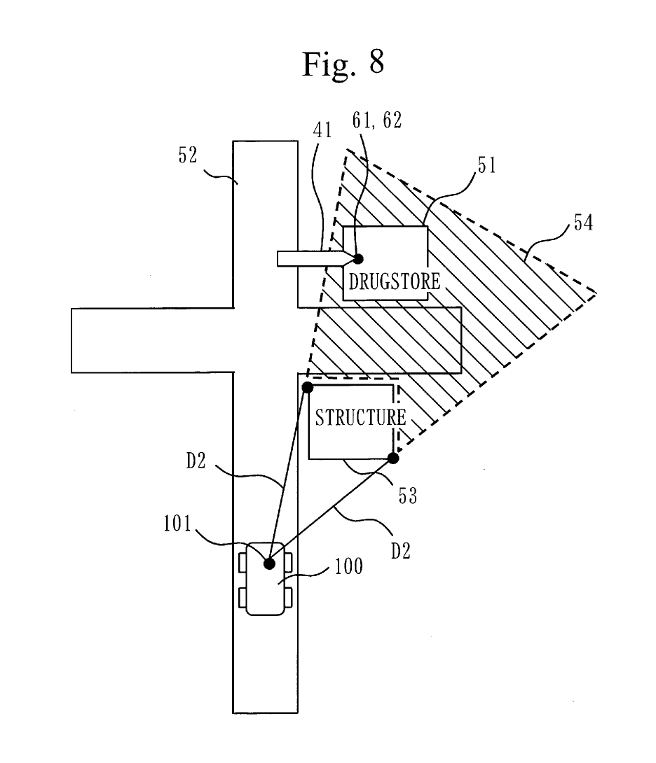

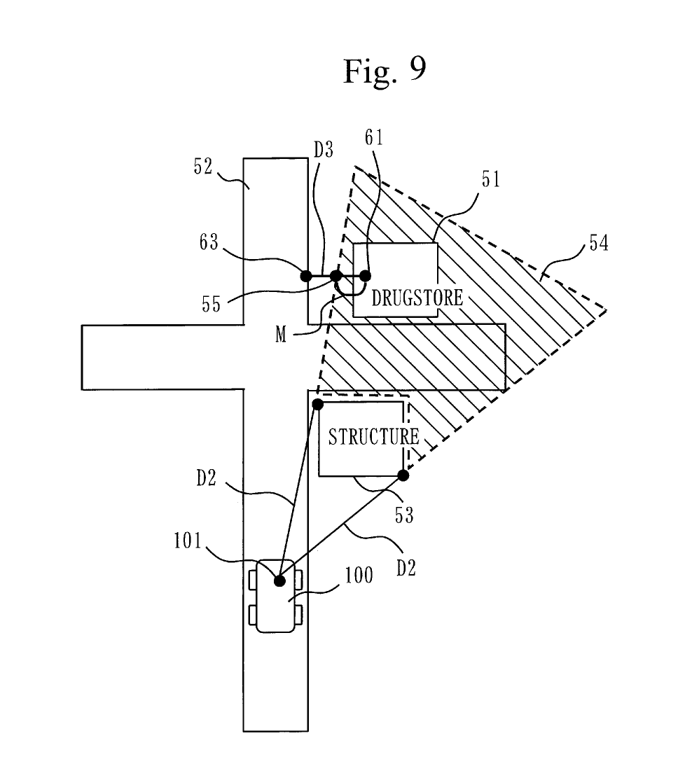

Specifically, as illustrated in FIG. 8, the visibility determination unit 22 computes two straight lines D2 that pass through the viewpoint position 101 and points at both ends of the structure 53. Herein, it is assumed that the structure 53 is rectangular, like the object 51 and latitudes and longitudes of four left upper, right upper, left lower, and right lower points when the structure 53 is seen from the sky are given in the map information. Accordingly, the visibility determination unit 22 can compute the two straight lines D2, using a method similar to the one for the two straight lines D1. The visibility determination unit 22 computes an area on the back side of the structure 53, as the invisible area 54. The visibility determination unit 22 writes the computed invisible area 54 into the memory 121.

In step S24, the visibility determination unit 22 determines whether or not the reference range 62 is in the invisible area 54 computed in step S23.

Specifically, the visibility determination unit 22 reads, from the memory 121, the reference position 61 computed in step S12 and the invisible area 54 computed in step S23. The visibility determination unit 22 identifies the reference range 62, using the reference position 61. Herein, the point indicated by the reference position 61 becomes the reference range 62. Then, the visibility determination unit 22 determines whether or not at least a portion of the identified reference range 62 is included in the invisible area 54 that has been read.

If the at least portion of the identified reference range 62 is included in the invisible area 54, the visibility determination unit 22 causes the procedure to proceed to step S25. If the at least portion of the identified reference range 62 is not included in the invisible area 54, the visibility determination unit 22 causes the procedure to proceed to step S26. That is, the visibility determination unit 22 determines whether or not the structure 53 that is present between this moving body 100 and the object 51 overlaps the reference range 62 based on the reference position 61 of the object 51 when the landscape is observed from the viewpoint position 101 of the driver of the moving body 100.

In step S25, the visibility determination unit 22 computes a movement amount M for moving the support image 41.

Specifically, as illustrated in FIG. 9, the visibility determination unit 22 computes a straight line D3 that connects the reference position 61 and a closest point 63 of the road 52 to the reference position 61, as seen from the sky. The visibility determination unit 22 computes the length of a line segment of the computed straight line D3 between, the reference position 61 and a boundary point 55 of the invisible area 54, as the moving amount M. The visibility determination unit 22 writes the computed moving amount M into the memory 121.

In step S26, the visibility determination unit 22 sets 0 as the movement amount M and writes 0 into the memory 121.

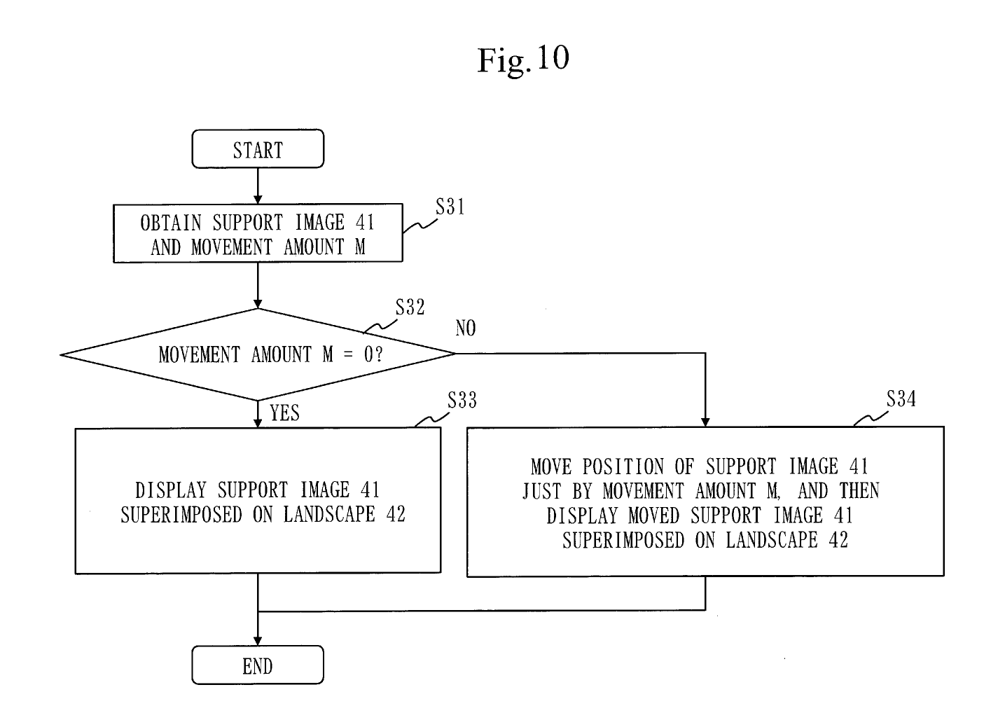

The display control process in step S3 according to the first embodiment will be described with reference to FIG. 10.

In step S31, the display control unit 23 reads and obtains the support image 41 generated in step S12 and the moving amount M computed in step S25 or the moving amount M set in step S26 from the memory 121.

In step S32, the display control unit 23 determines whether or not the moving amount M obtained in step S31 is 0.

If the moving amount M is 0, the display control unit 23 causes the procedure to proceed to step S33. If the moving amount M is not 0, the display control unit 23 causes the procedure to proceed to step S34.

In step S33, the display control unit 23 causes the display apparatus 32 to display the support image 41 obtained in step S31, such that the support image 41 without alteration is superimposed on the landscape 42, as illustrated in FIG. 3C.

In step S34, the display control unit 23 moves the support image 41 obtained in step S31 to the road 52 on which the moving body 100 travels, just by the moving amount M, and then causes the display apparatus 32 to display the moved support image 41 superimposed on the landscape 42. In other words, the display control unit 23 moves the support image 41 to a position where the position indicated by the support image 41 can be visually recognized from the moving body 100, and then causes the display apparatus 32 to display the moved support image 41 superimposed on the landscape 42, as illustrated in FIG. 4D. That is, the display control unit 23 moves the support image 41 to the position where the position indicated by the support image 41 does not overlap the structure 53 in the landscape, and then causes the display apparatus 32 to display the moved support image 41 superimposed on the landscape 42.

### Effect of First Embodiment

As mentioned above, when the reference range 62 based on the reference position 61 indicated by the support image 41 cannot be visually recognized, the support image display apparatus 10 according to the first embodiment moves the support image 41, and then causes the moved support image 41 superimposed on the landscape 42 to be displayed. With this arrangement, even for the structure located in a position that cannot be seen from the driver due to the different structure, the support image 41 can be so displayed that the driver may easily understand the support image 41.

### Alternative Configurations

### First Variation

In the first embodiment, the reference position 61 has been the point on the object 51. The reference position 61 in a first variation, however, may be a point located in a position that is in the vicinity of the object 51 and shifted from the object 51. As a specific example, the reference position 61 may be a point closer to the road 52 than to the object 51.

A difference of the first variation from the first embodiment will be described.

In the first variation, a different method of identifying the reference position 61 in step S12 is used.

The image generation unit 21 identifies one of the four points of the object 51 closest to the road 52 using the latitudes and longitudes of the four points indicated by the POI information and computes the position shifted from the identified point toward the point of the object 51 positioned diagonally to the identified point, by the certain distance. The image generation unit 21 shifts the computed point to outside the object 51 toward the road 52, and sets, as the reference position 61, a position obtained by shifting the shifted computed point in the height direction or shifting the shifted computed point from the ground surface in the vertical direction, just by the reference height.

In the first variation, a different method of computing two straight lines D1 in step S22 is used.

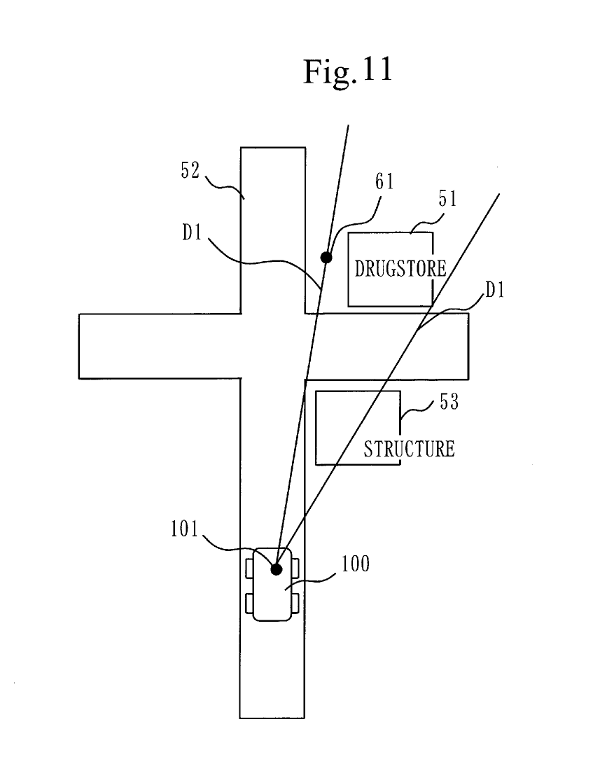

As illustrated in FIG. 11, the visibility determination unit 22 uses, in addition to the four points of the object 51 indicated by the POI information, a point indicating the reference position 61. In other words, the visibility determination unit 22 computes the two straight lines D1 which have connected the viewpoint position 101 and two of the points located at both ends of a total of five points that are the point indicating the reference position 61 and the four points of the object 51 indicated by the POI information.

In the first variation, a different method of identifying a reference range 62 in step S24 is used.

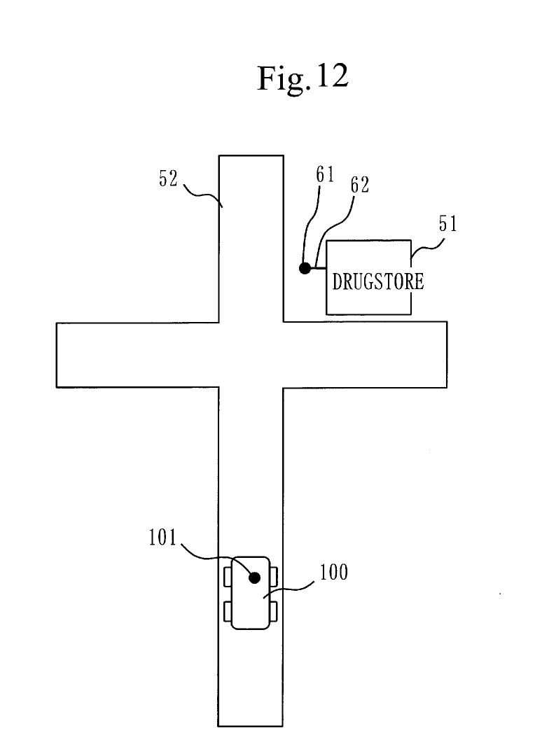

When the reference position 61 is located in a position shifted from the object 51 as illustrated in FIG. 12, the reference range 62 is a region between the reference position 61 and the object 51, as seen from the sky. More specifically, the reference range 62 is a region on a straight line that has connected the reference position 61 and a point on the object 51 closest to the reference position 61, as seen from the sky

Therefore, the visibility determination unit 22 computes the straight line that has connected the reference position 61 and the point on the object 51 closest to the reference position 61, as seen from the sky, and computes the region on the computed straight line, as the reference range 62.

In the first variation, a different method of computing a movement amount M in step S25 is used.

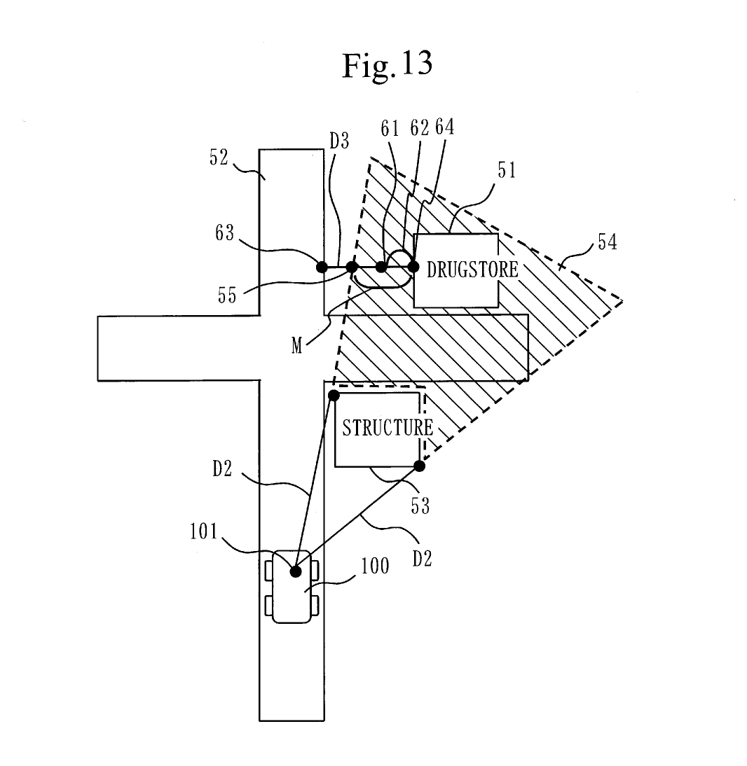

As illustrated in FIG. 13, the visibility determination unit 22 computes a straight line D3 that has connected an end point 64 of the reference range 62 on the side of the object 51 and a closest point 63 of the road 52. Then, the visibility determination unit 22 computes the length of a line segment of the computed straight line D3 between the end point 64 and a boundary point 55 of the invisible area 54, as the movement amount M.

### Second Variation

In the first embodiment, the support image 41 is moved to the road 52 when the reference range 62 cannot be visually recognized. However, as a second variation, when the reference range 62 cannot be visually recognized and a portion of the object 51 can be visually recognized from the driver, the support image 41 may be displayed after having been so moved that the position indicated by the support image 41 becomes a position of the object 51 that can be visually recognized by the driver. That is, when the structure 53 does not overlap the portion of the object 51 in the landscape, the support image 41 may be displayed after having been so moved that the position indicated by the support image 41 becomes the position of the object 51 that does not overlap the structure 53.

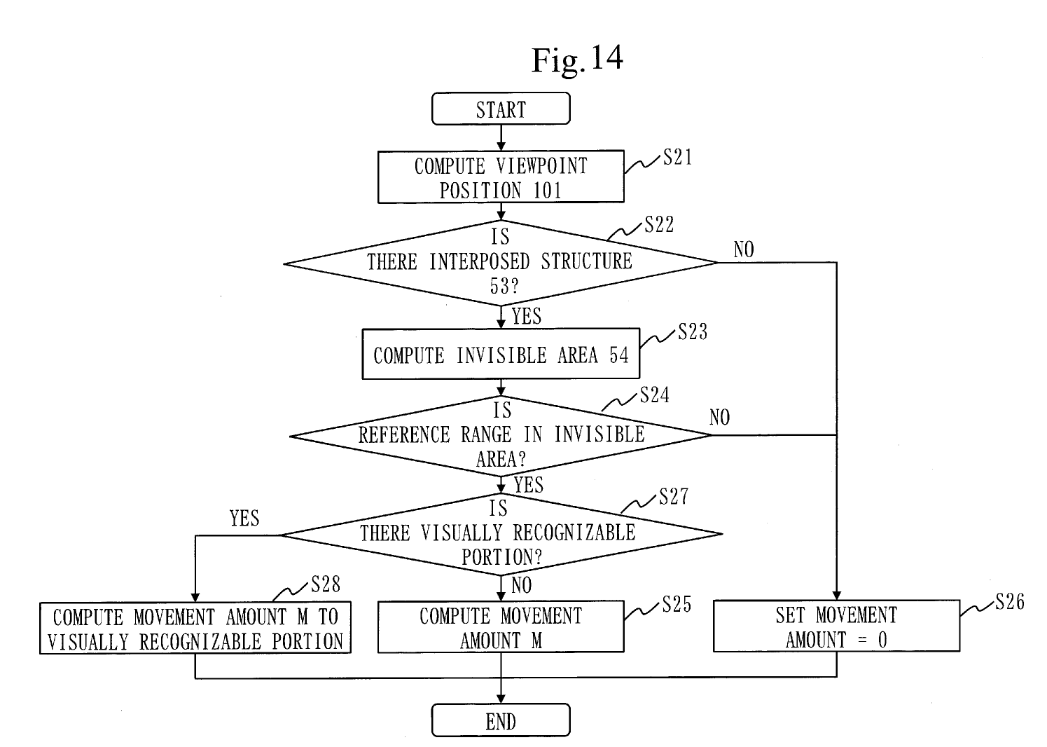

A visibility determination process in step S2 according to the second variation will be described with reference to FIG. 14.

Processes from step S21 to step S26 are the same as the processes from step S21 to step S26 in FIG. 6.

In step S27, the visibility determination unit 22 determines whether or not a portion of the object 51 can be visually recognized from the driver of the moving body 100.

Specifically, the visibility determination unit 22 reads, from the memory 121, the invisible area 54 computed in step S23. The visibility determination unit 22 determines whether or not the portion of the object 51 is outside the invisible area 54 that has been read.

If the portion of the object 51 is outside the invisible area 54, the visibility determination unit 22 causes the procedure to proceed to step S28, regarding that the portion of the object 51 can be visually recognized from the driver of the moving body 100. On the other hand, if even the portion of the object 51 is not outside the invisible area 54, the visibility determination unit 22 causes the procedure to proceed to step S25, regarding that the entirety of the object 51 cannot be visually recognized from the driver of the moving body 100.

In step S28, the visibility determination unit 22 computes a distance and a direction indicating the relative position of a point in a region of the object 51 located outside the invisible area 54 with respect to the reference position 61, as a movement amount M. A specific example of the point in the region of the object 51 not included in the invisible area 54 is the center point of the region of the object 51 not included in the invisible area 54.

### Third Variation

In the first embodiment, the function of each unit of the support image display apparatus 10 has been implemented by the software. As a third variation, however, the function of each unit of the support image display apparatus 10 may be implemented by hardware. A difference of this third variation from the first embodiment will be described.

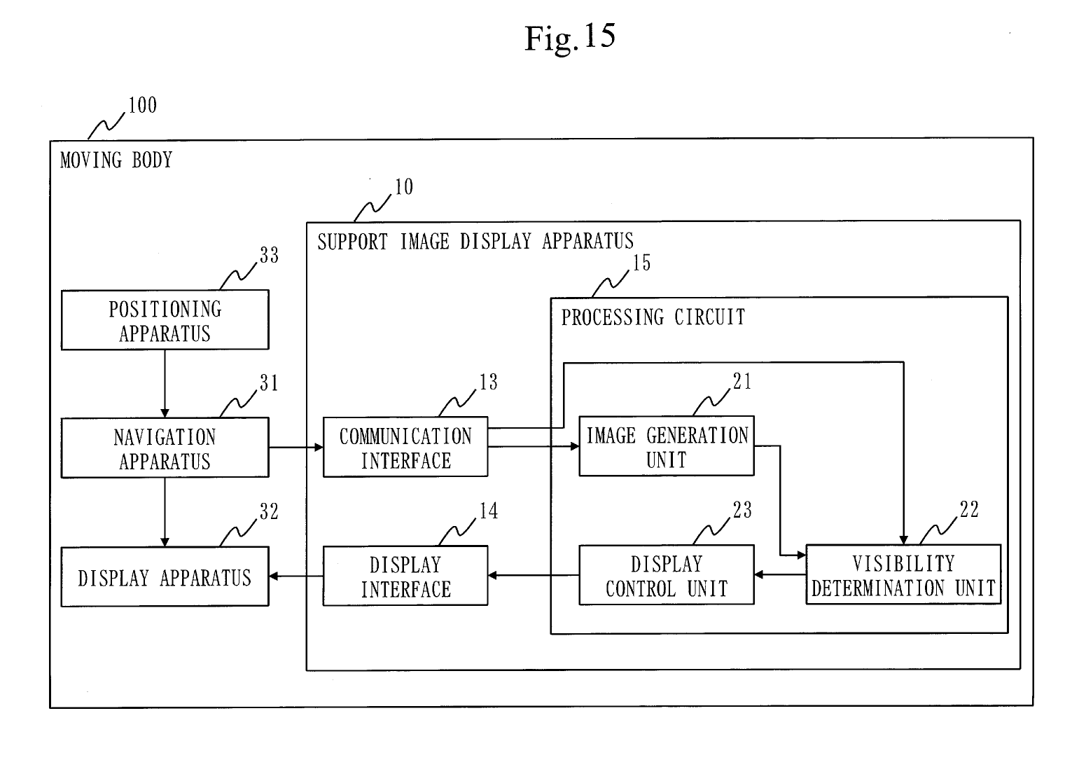

A configuration of the support image display apparatus 10 according to the third variation will be described with reference to FIG. 15.

When the function of each unit is implemented by the hardware, the support image display apparatus 10 includes a processing circuit 15, in place of the processor 11 and the storage device 12. The processing circuit 15 is an electronic circuit dedicated for implementing the function of each unit of the support image display apparatus 10 and a function of the storage device 12.

The processing circuit 15 is assumed to be a single circuit, a composite circuit, a programmed processor, a parallel-programed processor, a logic IC, a GA (Gate Array), an ASIC (Application Specific Integrated Circuit), or an FPGA (Field-Programmable Gate Array).

The function of each unit may be implemented by one processing circuit 15, or the function of each unit may be distributed into a plurality of the processing circuits 15, for implementation.

### Fourth Variation

As a fourth variation, a part of the functions may be implemented by hardware, and the other functions may be implemented by software. That is, the part of the functions of the respective units in the support image display apparatus 10 may be implemented by the hardware and the other functions may be implemented by the software.

The processor 11, the storage device 12, and the processing circuit 15 are collectively referred to as “processing circuitry”. That is, the functions of the respective units are implemented by the processing circuitry.

### Fifth Variation

In the first embodiment, the support image display apparatus 10 has been an apparatus separate from the navigation apparatus 31. The support image display apparatus 10 may be, however, integrally formed with the navigation apparatus 31.

Though the viewpoint position 101 has been assumed to be the viewpoint position 101 of the driver of the moving body 100 in this embodiment, the view point position 101 is not limited to this and may be the viewpoint position of a passenger except the driver. When a landscape is displayed in the form of an image obtained by the camera, the viewpoint position 101 may be the viewpoint position of the camera.

### Second Embodiment

A second embodiment is different from the first embodiment in that when a reference range 62 based on a reference position 61 indicated by a support image 41 cannot be visually recognized, the outline of the support image 41 is altered. In the second embodiment, this difference will be described.

### Description of Operations

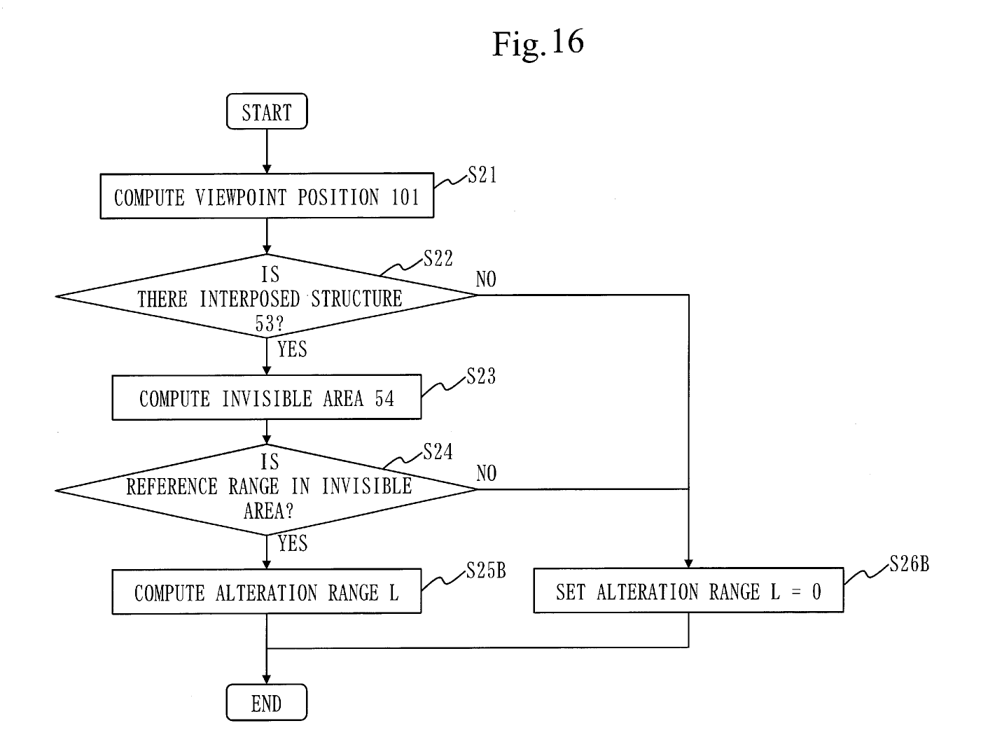

Operations of a support image display apparatus 10 according to the second embodiment will be described with reference to FIGS. 16 to 19.

The operations of the support image display apparatus 10 according to the second embodiment correspond to a support image display method according to the second embodiment. The operations of the support image display apparatus 10 according to the second embodiment also correspond to a support image display program procedure according to the second embodiment.

A visibility determination process in step S2 according to the second embodiment will be described with reference to FIG. 16.

Processes from step S21 to step S24 are the same as the processes from step S21 to step S24 illustrated in FIG. 6.

In step S25B, a visibility determination unit 22 computes an alteration range L in which the outline is altered.

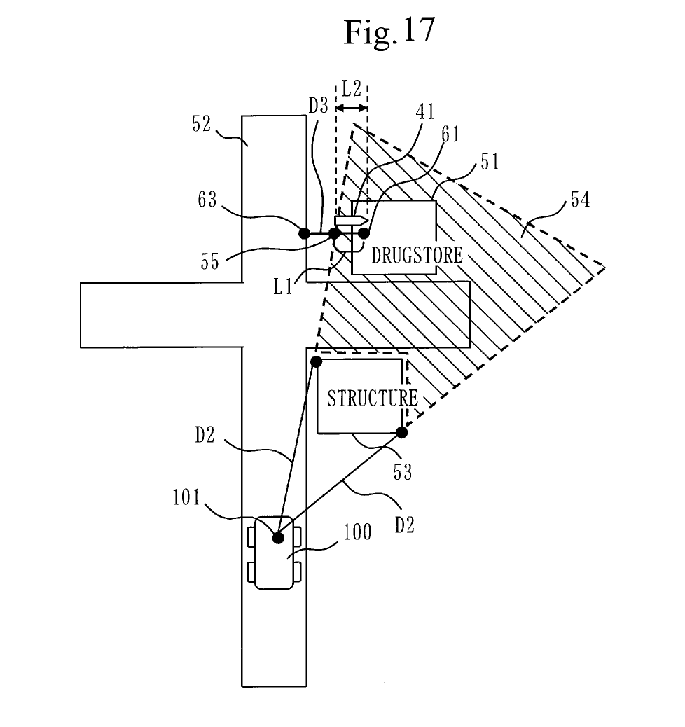

Specifically, as illustrated in FIG. 17, the visibility determination unit 22 computes a straight line D3 that connects a reference position 61 and a closest point 63 of a road 52 to the reference position 61, as seen from the sky. The visibility determination unit 22 computes a length L1 of a segment of the computed straight line D3 between the reference position 61 and a boundary point 55 of an invisible area 54. The visibility determination unit 22 sets a shorter one of the computed length L1 and a length L2 of the support image 41, as the alteration range L. The visibility determination unit 22 writes the computed alteration range L into a memory 121.

In step S26B, the visibility determination unit 22 sets 0 as the alteration range L and writes 0 into the memory 121.

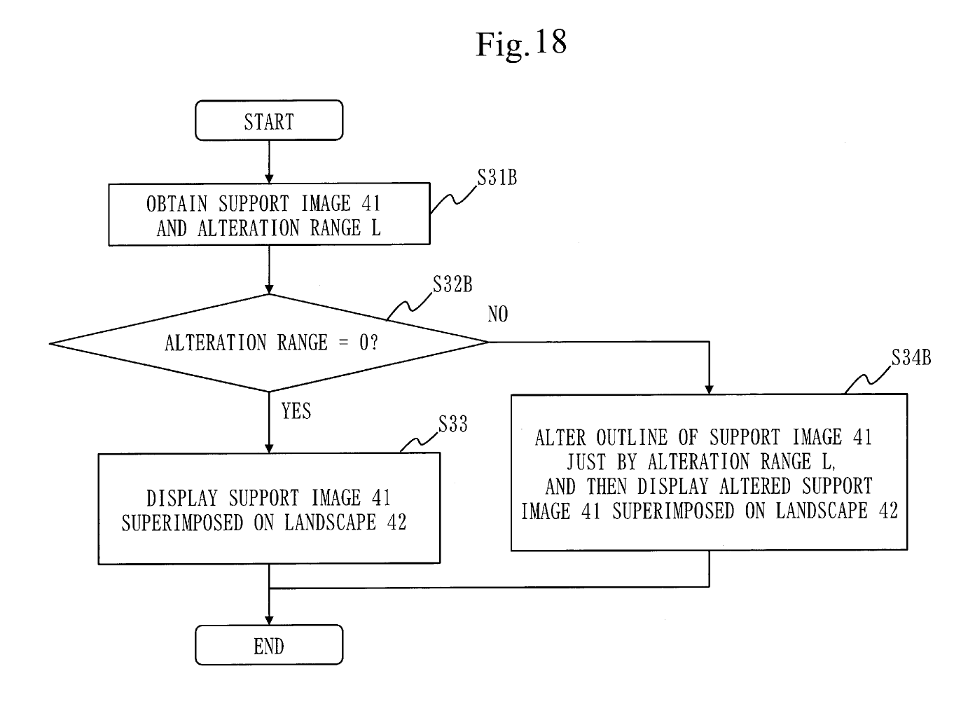

A display control process in step 3 according to the second embodiment will be described with reference to FIG. 18.

Step S33 is the same as the process of step S33 illustrated in FIG. 10.

In step S31B, a display control unit 23 reads and obtains the support image 41 generated in step S12 and the alteration range L computed in step S25B or the alteration range L set in step S26B from the memory 121.

In step S32B, the display control unit 23 determines whether or not the alteration range L obtained in step S31B is 0.

If the alteration range L is 0, the display control unit 23 causes the procedure to proceed to step S33. If the alteration range L is not 0, the display control unit 23 causes the procedure to proceed to step S34B.

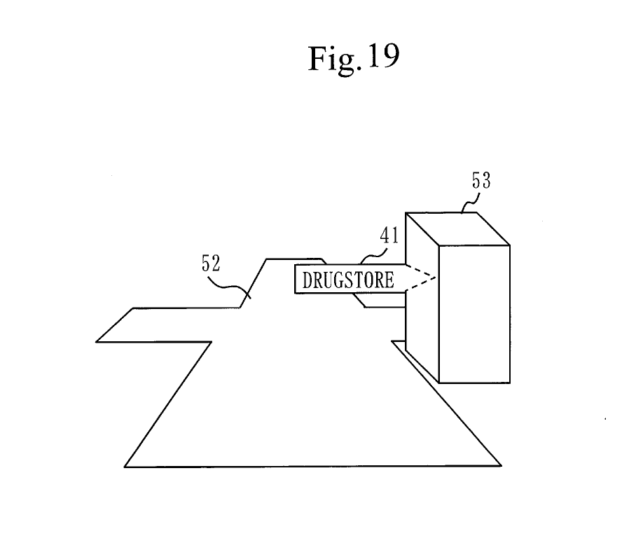

In step S34B, the display control unit 23 alters the outline of a range from the tip to the alteration range L in the support image 41 obtained in step S31B to a broken line or the like, and then causes a display apparatus 32 to display the altered support image 41 superimposed on a landscape 42. In other words, as illustrated in FIG. 19, the display control unit 23 alters the outline of a portion of the support image 41 that overlaps a structure 53 that is present between the moving body 100 and the reference range 62, and then causes the display apparatus 32 to display the altered support image 41 superimposed on the landscape 42.

### Sixth Variation

In the second embodiment, the function of each unit of the support image display apparatus 10 has been implemented by the software, as in the first embodiment. The function of each unit of the support image display apparatus 10 may be, however, implemented by the hardware, as in the third variation of the first embodiment. Alternatively, as in the fourth variation of the first embodiment, a part of the functions of the respective units in the support image display apparatus 10 may be implemented by the hardware and the other functions may be implemented by the software.

The above description has been given about the embodiments and the variations of the present invention. Some of these embodiments and variations may be carried out in combination. Alternatively, any one or some of the embodiments and the variations may be partially carried out. The present invention is not limited to the embodiments and the variations described above, and various modifications are possible as necessary.

### REFERENCE SIGNS LIST

10: support image display apparatus; 11: processor; 12: storage device; 121: memory; 122: storage; 13: communication interface; 14: display interface; 15:

processing circuit; 21: image generation unit; 22: visibility determination unit; 23: display control unit; 31: navigation apparatus; 32: display apparatus; 33: positioning apparatus; 41: support image; 42: landscape; 51: object; 52: road; 53: structure; 54: invisible area; 55: boundary point; 61: reference position; 62: reference range; 63: closest point; 64: end point; 100: moving body

1-9. (canceled)

10. A support image display apparatus to cause a support image to be displayed, such that the support image is superimposed on a landscape that is observed from a viewpoint position of a moving body, the support image indicating a reference position of an object included in the landscape, the support image display apparatus comprising:
processing circuitry to:
generate the support image;
determine whether or not a structure that is present between the moving body and the object overlaps a reference range based on the reference position of the object, in the landscape; and
alter the support image and cause the altered support image to be displayed when the reference range overlaps the structure.

11. The support image display apparatus according to claim 10,
wherein when the reference range overlaps the structure, the processing circuitry alters a position of the support image and then causes the altered support image to be displayed.

12. The support image display apparatus according to claim 11,
wherein the processing circuitry moves the support image to a road where the moving body travels, to a position where a position indicated by the support image does not overlap the structure in the landscape, and then causes the moved support image to be displayed.

13. The support image display apparatus according to claim 11,
wherein the processing circuitry determines whether or not the structure overlaps a portion of the object, in the landscape; and
wherein when the structure does not overlap the portion of the object, the processing circuitry moves the support image so that a position indicated by the support image becomes a position of the object that does not overlap the structure, and then causes the moved support image to be displayed.

14. The support image display apparatus according to claim 10,
wherein when the reference range overlaps the structure, the processing circuitry alters an outline of the support image and then causes the altered support image to be displayed.

15. The support image display apparatus according to claim 14,
wherein the processing circuitry alters the outline of a portion of the support image that overlaps the structure in the landscape and then causes the altered support image to be displayed.

16. The support image display apparatus according to claim 10,
wherein when the reference position is on the object, the reference range is a point indicating the reference position, and when the reference position is in a position shifted from the object, the reference range is a region between the reference position and the object.

17. The support image display apparatus according to claim 11,
wherein when the reference position is on the object, the reference range is a point indicating the reference position, and when the reference position is in a position shifted from the object, the reference range is a region between the reference position and the object.

18. The support image display apparatus according to claim 12,
wherein when the reference position is on the object, the reference range is a point indicating the reference position, and when the reference position is in a position shifted from the object, the reference range is a region between the reference position and the object.

19. The support image display apparatus according to claim 13,
wherein when the reference position is on the object, the reference range is a point indicating the reference position, and when the reference position is in a position shifted from the object, the reference range is a region between the reference position and the object.

20. The support image display apparatus according to claim 14,
wherein when the reference position is on the object, the reference range is a point indicating the reference position, and when the reference position is in a position shifted from the object, the reference range is a region between the reference position and the object.

21. The support image display apparatus according to claim 15, wherein when the reference position is on the object, the reference range is a point indicating the reference position, and when the reference position is in a position shifted from the object, the reference range is a region between the reference position and the object.

22. A support image display method of causing a support image to be displayed, such that the support image is superimposed on a landscape that is observed from a viewpoint position of a moving body, the support image indicating a reference position of an object included in the landscape, the support image display method comprising:
generating the support image;
determining whether or not a structure that is present between the moving body and the object overlaps a reference range based on the reference position of the object, in the landscape; and
altering the support image and causing the altered support image to be displayed when the reference range overlaps the structure.

23. A non-transitory computer readable medium storing a support image display program of causing a support image to be displayed, such that the support image is superimposed on a landscape that is observed from a viewpoint position of a moving body, the support image indicating a reference position of an object included in the landscape, the support image display program causing a computer to execute:
an image generation process of generating the support image;
a visibility determination process of determining whether or not a structure that is present between the moving body and the object overlaps a reference range based on the reference position of the object, in the landscape; and
a display control process of altering the support image and causing the altered support image to be displayed when the reference range overlaps the structure.
